(19) United States
(12) Patent Application Publication
(10) Pub. No.: US 2025/0128579 A1
(43) Pub. Date: Apr. 24, 2025

(54) VEHICLE DOOR STRUCTURE

(71) Applicant: HONDA MOTOR CO., LTD., Tokyo (JP)

(72) Inventors: Eiji HIRANO, Wako-shi (JP); Masahiro TANIGAWA, Wako-shi (JP); Takeru SATO, Tokyo (JP)

(21) Appl. No.: 18/915,532

(22) Filed: Oct. 15, 2024

(30) Foreign Application Priority Data
Oct. 19, 2023 (JP) 2023-180074

(51) Int. Cl. B60J 5/04

(52) U.S. Cl. CPC B60J 5/0443; B60J 5/045

(57) ABSTRACT

A vehicle door structure includes: an inner panel including a forward portion, lower portion, and a rearward portion; an outer panel disposed on a vehicle outer side of the inner panel; and a reinforcement member installed between the inner panel and the outer panel. The reinforcement member is disposed extending continuously over the forward portion, the lower portion, and the rearward portion of the inner panel.

### CROSS REFERENCE TO RELATED APPLICATIONS

This application claims foreign priority to Japanese Patent Application No. 2023-180074, filed Oct. 19, 2023, the disclosure of which is incorporated herein by reference in its entirety.

### TECHNICAL FIELD

This invention relates to a vehicle door structure.

### BACKGROUND ART

Generally, a door mounted in an automobile is composed of an inner panel, an outer panel, and a reinforcement member (see, for example, Japanese Patent No. 6252507).

The vehicle exterior member and vehicle back door described in Japanese Patent No. 6252507 has, as illustrated in FIG. 8 thereof, an outer edge outer panel (70) and an outer edge outer panel (72) as reinforcement members. The outer edge outer panel (70) is an L-shaped member joined to a front edge portion of the door inner panel (62) and to a forward portion of a lower edge portion of the door inner panel (62). The outer edge outer panel (72) is an inverted L-shaped member joined to a rear edge portion of the door inner panel (62) and to a rearward portion of the lower edge portion of the door inner panel (62).

### SUMMARY

In the vehicle exterior member and the back door of the vehicle described in Japanese Patent No. 6252507, the forward outer edge outer panel (70) and the rearward outer edge outer panel (72) are spaced apart in the front-rear direction in a state of being disconnected. Therefore, the side door body (60) has weak rigidity at lower part of the door, and there was room for improvement to ensure the rigidity of the lower part of the door.

In view of this, an object of the present invention is to provide a vehicle door structure in which the rigidity of lower part of the door is improved.

An aspect of the embodiment according to the present invention is a vehicle door structure including: an inner panel including a forward portion, lower portion, and a rearward portion; an outer panel disposed on a vehicle outer side of the inner panel; and a reinforcement member installed between the inner panel and the outer panel. The reinforcement member is disposed extending continuously over the forward portion, the lower portion, and the rearward portion of the inner panel.

The present invention can provide a vehicle door structure that can improve the rigidity of the lower part of the door.

### BRIEF DESCRIPTION OF THE DRAWINGS

FIG. 1 is a schematic side view of a vehicle door structure according to an embodiment of the present invention, showing installation of an inner panel of a front door as seen from the outside of the vehicle.

FIG. 2 is a schematic side view of the vehicle door structure according to the embodiment of the present invention, showing installation of a window regulator of the front door as seen from the outside of the vehicle.

FIG. 3 is an enlarged cross-sectional view taken along line III-III in FIG. 1.

FIG. 4 is an enlarged cross-sectional view taken along line IV-IV in FIG. 1.

FIG. 5 is an enlarged cross-sectional view taken along line V-V in FIG. 1.

FIG. 6 is a schematic side view of a vehicle door structure according to the embodiment of the present invention, showing installation of an inner panel of a rear door as seen from the outside of the vehicle.

FIG. 7 is an enlarged cross-sectional view taken along line VII-VII in FIG. 6.

FIG. 8 is an enlarged cross-sectional view taken along line VIII-VIII in FIG. 6.

FIG. 9 is an enlarged cross-sectional view taken along line IX-IX in FIG. 6.

FIG. 10 is an enlarged view of portion A in FIG. 6.

FIG. 11 is an enlarged perspective view of portion A of FIG. 6 from the back side.

### DETAILED DESCRIPTION OF EMBODIMENT

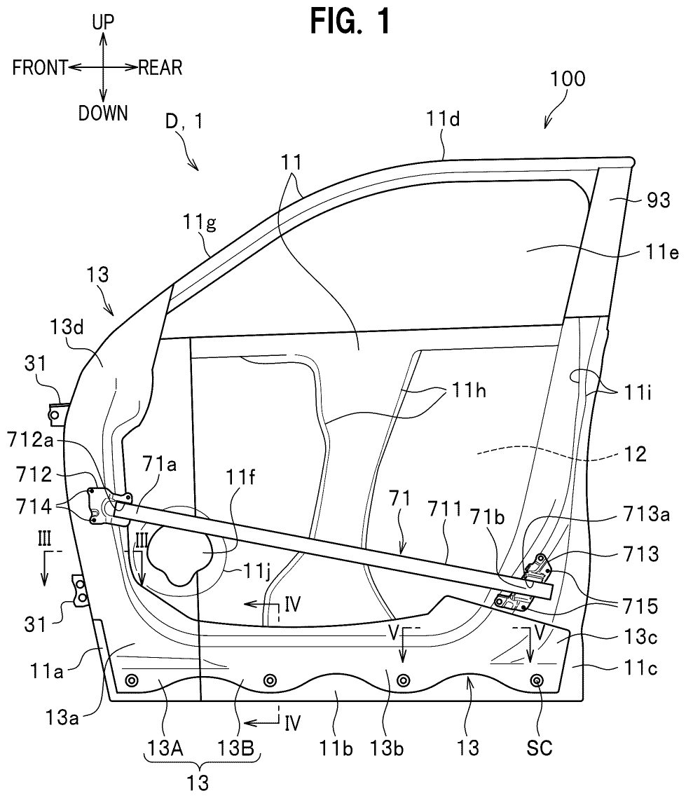

A description will be given of an example of a vehicle door structure 100 according to an embodiment of the present invention, with reference to FIGS. 1 to 11.

The direction of travel of the vehicle is described as “front”; the backward direction as “rear”; the vertical upward direction as “up”; the vertical downward direction as “down”; and the vehicle width directions as “left” and “right.

### Vehicle

A vehicle to which the vehicle door structure 100 according to the embodiment of the present invention is applied is not limited in the form and type, as long as the vehicle is equipped with a door(s) D (front door 1 and/or rear door 2) as illustrated in FIGS. 1, 2, and 6. The vehicle body, for example, has door openings (not shown) for installing the doors D in an openable and closable manner.

### Vehicle Door Structure

The vehicle door structure 100 has a door D. The door D includes an inner panel 11, an outer panel 12, and a reinforcement member 13, or includes an inner panel 21, an outer panel 22, and a reinforcement member 23.

### Door

As illustrated in FIGS. 1, 2, and 6, the door D is assumed to include the inner panel 11, the outer panel 12, and the reinforcement members 13, or include the inner panel 21, the outer panel 22, and the reinforcement member 23. The other form of the door D is not specifically limited. In other words, the door D is a side door that opens and closes a door opening (not shown) of a vehicle body.

Hereinafter, description is given of, as examples of the door D, a front door 1 and a rear door 2, which are each of the hinged rear-opening type and located on a lateral side of the vehicle body.

### Front Door

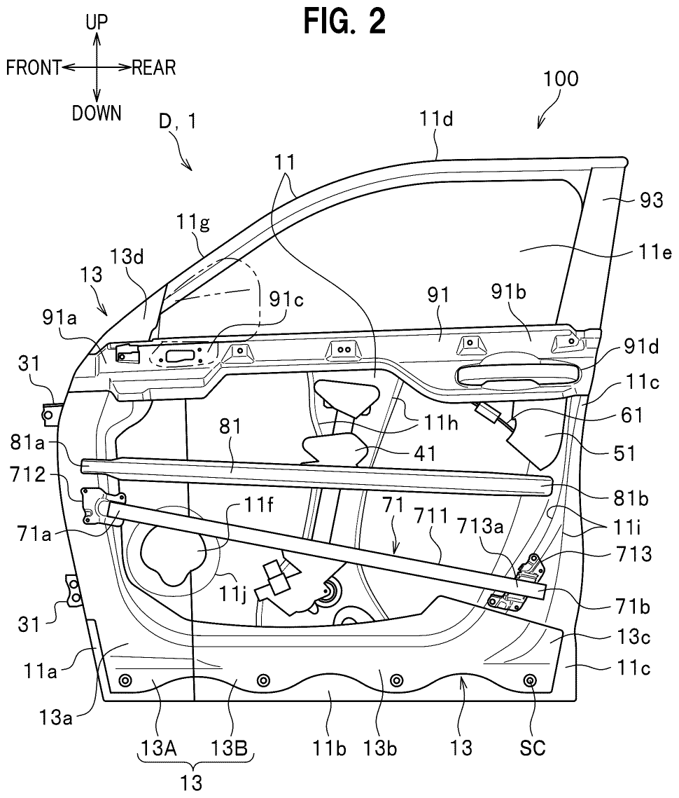

The front door 1 shown in FIG. 1 or FIG. 2 is a front side door located in a forward part of a lateral side of the vehicle body. The front door 1 has the inner panel 11, the outer panel 12, the reinforcement member 13, a door beam 71, a skin stiffener 81, a skin upper stiffener 91, door hinges 31, a window glass (not shown), a lining (not shown), a window regulator 41 (see FIG. 2), a door lock device 51 (see FIG. 2), and electrical components 61 such as harnesses (see FIG. 2).

### Inner Panel

As illustrated in FIG. 1, the inner panel 11 is a door body that constitutes the framework of the front door 1. The inner panel 11 is formed of a metal sheet member, such as a rolled steel sheet. The inner panel 11 has a window opening 11e, a speaker installation hole 11f, and a sash 11g. The inner panel 11 includes a forward portion 11a and a rearward portion 11c to which a front end portion 71a and a rear end portion 71b of the door beam 71 are fixed respectively. The inner panel 11 includes an upper portion 11d in which the window opening 11e is formed.

As illustrated in FIG. 2, a periphery portion of the outer panel 12 (see FIGS. 3 to 5) is fixed to a vehicle width direction outer periphery portion of the inner panel 11 with the door beam 71, skin stiffener 81, and skin upper stiffener 91 located therebetween. The inner panel 11 is connected to a front pillar (not shown) with a pair of upper and lower door hinges 31, 31 attached to a front end portion of the inner panel 11, in an openable and closable manner. The rear end side of the inner panel 11 is held in a door-closed state by the door lock device 51.

As illustrated in FIG. 2, the window opening 11e is where the window glass (not shown) is arranged. The window opening 11e is formed of the sash 11g of the inner panel 11, a skin sash stiffener 93 installed so as to be overlapped on the sash 11g, and a skin upper stiffener 91 provided at a lower outer edge portion of the window opening 11e.

The sash 11g is a window frame that supports the periphery of the window glass (not shown).

The speaker installation hole 11f is a hole where a speaker (not shown) is mounted. The speaker is mounted in the speaker installation hole 11f, for example, with a not-shown anti-vibration sealant located therebetween. The speaker installation hole 11f is formed in a lower forward portion of the inner panel 11. A bead 11j is formed in a peripheral portion of the speaker installation hole 11f to reinforce the speaker installation hole 11f.

As illustrated in FIG. 1 or FIG. 2, bead 11h is a reinforcement for reinforcing the portion where the window regulator 41 is installed. The bead 11h extends in an up-down direction in a central portion of the inner panel 11.

The bead 11i is a reinforcement for reinforcing the area where the door lock device 51 is installed. The bead 11i is provided extending in the up-down direction in the rearward portion 11c of the inner panel 11.

As illustrated in FIG. 2, the beads 11h, 11i, 11j are each composed of concave groove-like depressions recessed into the inner panel 11 or bulges protruding from the inner panel 11 and having a convex shape in cross-sectional view. The beads 11h, 11i, 11j serve to reinforce the installation faces of the window regulator 41, door lock device 51, speaker (not shown), and the like and to make them difficult to bend.

### Outer Panel

As illustrated in FIGS. 1 and 3 to 4, the outer panel 12 is composed of a thin sheet-like resin member, which is disposed on the vehicle outer side of the inner panel 11. The outer panel 12 is detachably attached to the vehicle width direction outer side of the inner panel 11. Therefore, when the outer panel 12 is detached from the inner panel 11, the installation areas of the window regulator 41, the door lock device 51, and the like appear in the door D, which facilitates mounting operation of the window regulator 41, the door lock device 51, and the like.

### Reinforcement Member

As illustrated in FIG. 1, reinforcement member 13 is composed of a metal sheet member, which is installed between the inner panel 11 and the outer panel 12. The reinforcement member 13 is disposed on the inner panel 11 so as to extend continuously over the inner panel 11, from the forward portion 11a to the rearward portion 11c via the lower portion 11b. The reinforcement member 13 is thus formed in an L-shape (or U-shape) in side view. The door D equipped with such reinforcement member 13 increases the rigidity of the lower part of the door.

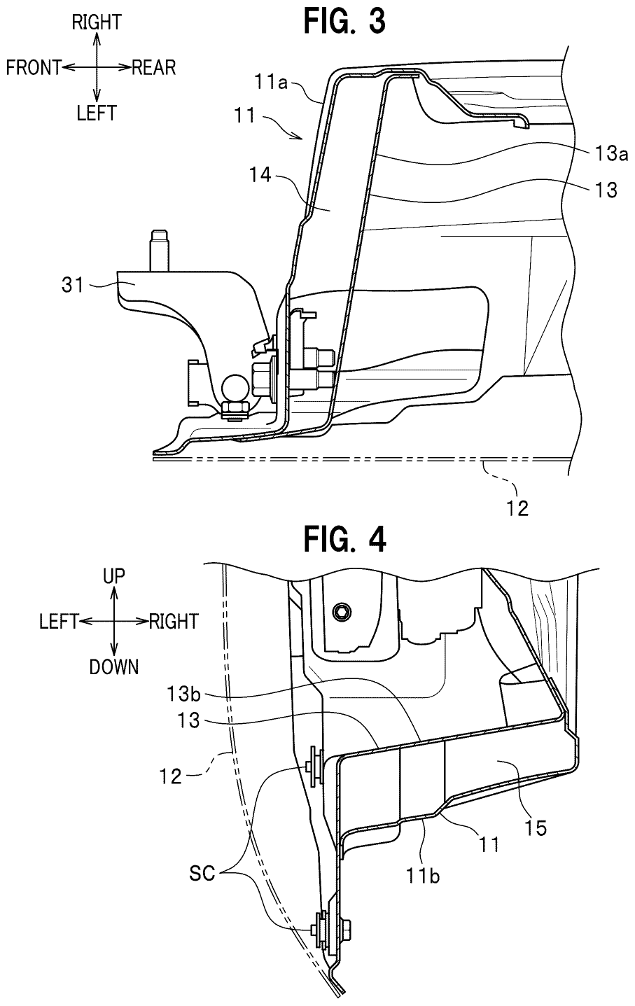

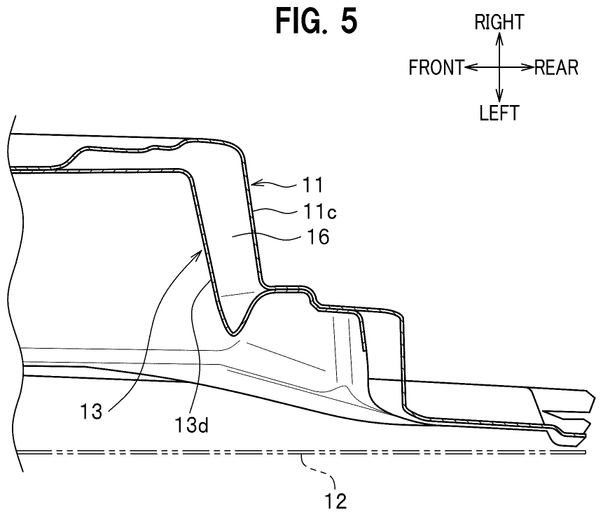

The reinforcement member 13 and inner panel 11 together form a front closed cross-sectional portion 14 (see FIG. 3), a lower closed cross-sectional portion 15 (see FIG. 4), and a rear closed cross-sectional portion 16 (see FIG. 5). Due to this, the reinforcement member 13, which has an L-shape (or U-shape) in side view, is reinforced extending from a forward portion 13a to a rearward portion 13c via a lower portion 13b. An upper portion 13d of the reinforcement member 13 extends from the lower portion 13b to a front lower end portion (to at least a portion of the peripheral edge) of the window opening 11e.

The reinforcement member 13 is composed of a forward reinforcement member 13A extending in the up-down direction in the forward portion 13a and a lower reinforcement member 13B extending in the front-rear direction in the lower portion 13b, which are continuously joined in a state of being flush with each other into an integral piece.

It should be noted that, in the case of the embodiment, as illustrated in FIGS. 1 and 2, the rearward portion 13c of the reinforcement member 13 has a short length in the up-down direction, so that the overall shape of the reinforcement member 13 is an L-shape. However, the length of the rearward portion 13c in the up-down direction may be increased to make the overall shape U-shaped.

As illustrated in FIG. 3, the front closed cross-sectional portion 14 is formed between the reinforcement member 13 and the forward portion 11a of the inner panel 11. Due to this, the rigidity of the forward portion 11a of the inner panel 11 is increased. The front closed cross-sectional portion 14 has a closed cross-section extending in the up-down direction and has an approximately rectangular shape elongated in the left-right direction. The front closed cross-sectional portion 14 extends to the vicinity of the front end portion of the sash 11g.

As illustrated in FIG. 4, the lower closed cross-sectional portion 15 is formed between the reinforcement member 13 and the lower portion 11b of the inner panel 11. The lower closed cross-sectional portion 15 has a closed cross-section extending in the front-rear direction and has an approximately rectangular shape elongated in the left-right direction. Due to this, the rigidity of the lower portion 11b of the inner panel 11 is increased. The reinforcement member 13 and the lower portion 11b of the inner panel 11 are connected by slide clips SC.

As illustrated in FIG. 5, the rear closed cross-sectional portion 16 is formed between the reinforcement member 13 and the rearward portion 11c of the inner panel 11. The rear closed cross-sectional portion 16 has a closed cross-section extending in the up-down direction and has an approximately rectangular shape elongated in the left-right direction. Due to this, the rigidity of the rearward portion 11c of the inner panel 11 is increased. In the case of the present embodiment, the rear closed cross-sectional portion 16 has a shorter dimension in the up-down direction than the front closed cross-sectional portion 14.

### Door Beam

As illustrated in FIG. 1, the door beam 71 is a door reinforcement member for reinforcing the front door 1. The door beam 71 is disposed slightly obliquely downward in the front-rear direction with respect to the front door 1. The door beam 71 having a straight shape and the reinforcement member 13 having an L-shape in side view form a truss structure having a triangular configuration in side view. The front end portion 71a of the door beam 71 is detachably attached via a beam bracket 712 to the reinforcement member 13 provided on the forward portion 11a of the inner panel 11. The rear end portion 71b of the door beam 71 is detachably attached via a beam bracket 713 to the rearward portion 11c of the inner panel 11. In other words, the rear end portion 71b of the door beam 71 is disposed adjacent to the rearward portion 13c of the reinforcement member 13. The door beam 71 is composed of a beam body 711, the front beam bracket 712, and the rear beam bracket 713.

The beam body 711, for example, is formed of a metal pipe having a straight shape.

The front beam bracket 712 is a metal plate bracket for attaching the front end portion 71a of the beam body 711 to the forward portion 13a of the reinforcement member 13. The beam bracket 712 has an engagement groove 712a to which the front end portion 71a of the door beam 71 is joined and bolt installation holes (not shown) into which fasteners 714 that fix the beam bracket 712 to the forward portion 13a of the reinforcement member 13 are installed.

As illustrated in FIG. 1, the rear beam bracket 713 is a metal plate bracket for attaching the rear end portion 71b of the beam body 711 to the rearward portion 11c of the inner panel 11. The beam bracket 713 has an engagement groove 713a to which the rear end portion 71b of the door beam 71 is joined and bolt installation holes (not shown) into which fasteners 715 that detachably fix the beam bracket 713 to the rearward portion 11c of the inner panel 11 are installed.

### Skin Stiffener

As illustrated in FIG. 2, the skin stiffener 81, like the door beam 71, is a door reinforcement member for reinforcing the front door 1. The skin stiffener 81 is, for example, formed of a metal sheet member extending in the front-rear direction and having an approximately U-shape in cross-sectional view. The skin stiffener 81 includes a front end portion 81a fixed to the forward portion 13a of the reinforcement member 13 and a rear end portion 81b fixed to the rearward portion 11c of the inner panel 11.

### Skin Upper Stiffener

The skin upper stiffener 91 is a metal reinforcement sheet member disposed on a vehicle outer side lower portion of the window opening 11e of inner panel 11. The skin upper stiffener 91 includes a front end portion 91a fixed to the forward portion 13a of the reinforcement member 13 and a rear end portion 91b fixed to the rearward portion 11c of the inner panel 11. The skin upper stiffener 91 is located between the inner panel 11 and the outer panel 12. The front end portion 91a and the rear end portion 91b of the skin upper stiffener 91 have a larger width in the up-down direction than a central portion of the skin upper stiffener 91 to increase the rigidity. The skin upper stiffener 91 has a door-mirror installation area 91c on the front end portion 91a and a door handle installation area 91d on the rear end portion 91b.

### Skin Sash Stiffener

The skin sash stiffener 93 is a metal reinforcement sheet member that is placed over the entirety of a rearward portion of the sash 11g of the inner panel 11. The skin sash stiffener 93 is installed extending from the rear upper end to the rear lower end of the sash 11g.

### Door Hinge

As illustrated in FIG. 1, the door hinges 31, 31 are hinge members for mounting the front door 1 to the vehicle body to be rotatable with respect to the vehicle body. The door hinges 31, 31 are attached to upper and lower portions of the front end portion of the front door 1, respectively.

### Rear Door

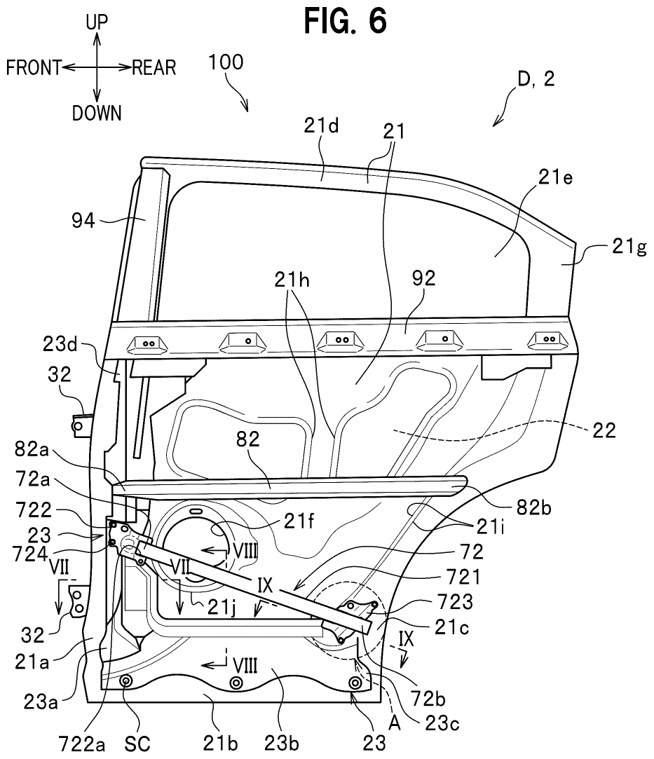

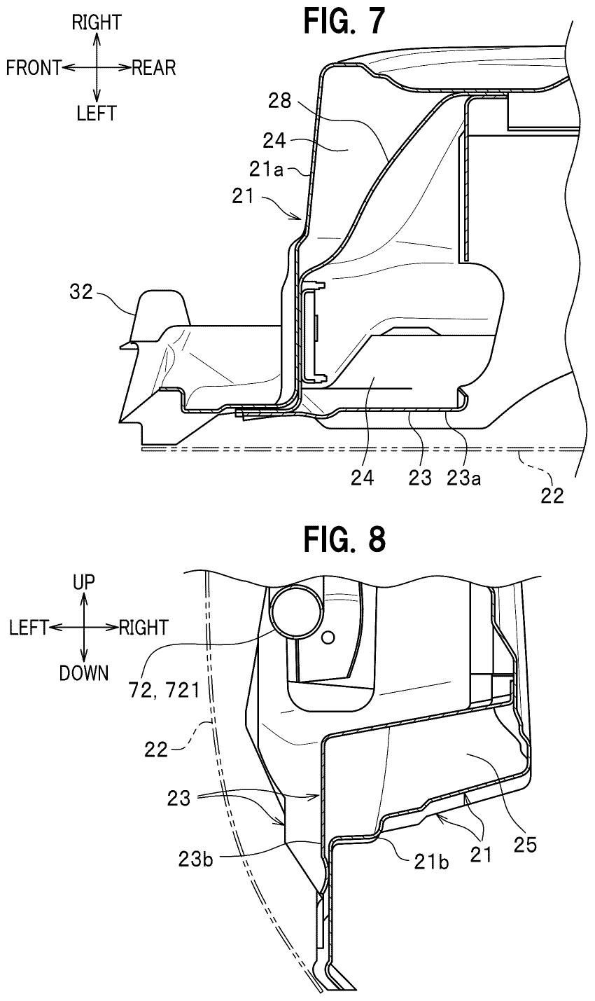

As illustrated in FIG. 6, rear door 2 is a rear side door located in the rearward part of the lateral side of the vehicle body. The rear door 2 includes the inner panel 21, the outer panel 22, the reinforcement member 23, a door beam 72, a skin stiffener 82, a skin upper stiffener 92, a hinge stiffener 28 (see FIG. 7), a door hinge 32, a window glass (not shown), a lining (not shown) window regulator (not shown), a door lock device (not shown), other electrical components such as harnesses (not shown).

### Inner Panel

As illustrated in FIG. 6, the inner panel 21 is a door body that constitutes the framework of the rear door 2, like the inner panel 11 of the front door 1. The inner panel 21 is formed of a metal sheet member, such as a rolled steel sheet. The inner panel 21 has a window opening 21e, a speaker installation hole 21f, and a sash 21g. The inner panel 21 includes a forward portion 21a and a rearward portion 21c to which a front end portion 72a and a rear end portion 72b of the door beam 72 are respectively fixed and to which a front end portion 82a and a rear end portion 82b of the skin stiffener 82 are respectively fixed. The inner panel 21 includes an upper portion 21d in which the window opening 21e is formed.

A periphery portion of the outer panel 22 is fixed to a vehicle width direction outer periphery portion of the inner panel 21 with the door beam 72, skin stiffener 82, and skin upper stiffener 92 located therebetween. The inner panel 21 is connected to a center pillar (not shown) with a pair of upper and lower door hinges 32, 32 attached to a front end portion of the inner panel 21, in an openable and closable manner. The rear end side of the inner panel 21 is held in a door-closed state by a door lock device (not shown).

As illustrated in FIG. 6, the window opening 21e is where the window glass (not shown) is arranged. The window opening 21e is formed of the sash 21g of the inner panel 21, a skin sash stiffener 94 installed so as to be overlapped on the sash 21g, and a skin upper stiffener 92 provided at a lower outer edge portion of the window opening 21e.

The sash 21g is a window frame that supports the periphery of the window glass (not shown).

The speaker installation hole 21f is a hole where a speaker (not shown) is mounted, like the speaker installation hole 11f in the front door 1. The speaker is mounted in the speaker installation hole 21f, for example, with an anti-vibration sealant (not shown) located therebetween. The speaker installation hole 21f is formed in a lower forward portion of the inner panel 21. A bead 21j is formed in a peripheral portion of the speaker installation hole 21f to reinforce the speaker installation hole 21f.

The bead 21h is a reinforcement for reinforcing the portion where a window regulator (not shown) is installed. The bead 21h extends in an up-down direction in a central portion of the inner panel 21.

The bead 21i is a reinforcement for reinforcing the area where a door lock device (not shown) is installed. The bead 21i is provided extending in the up-down direction in the rearward portion 21c of the inner panel 21.

The beads 21h, 21i, 21j are each composed of concave groove-like depressions recessed into the inner panel 21 or bulges protruding from the inner panel 21 and having a convex shape in cross-sectional view. The beads 21h, 21i, 21j serve to reinforce the installation faces of a window regulator (not shown), the door lock device (not shown), a speaker (not shown), and the like and to make them difficult to bend.

### Outer Panel

As illustrated in FIG. 6, the outer panel 22 is composed of a thin sheet-like resin member, which is disposed on the vehicle outer side of the inner panel 21. The outer panel 22 is detachably attached to the inner panel 21.

### Reinforcement Member

The reinforcement member 23 is composed of a metal sheet member, which is installed between the inner panel 21 and the outer panel 22. The reinforcement member 23 is disposed on the inner panel 21 so as to extend continuously over the inner panel 21, from the forward portion 21a to the rearward portion 21c via the lower portion 21b. The reinforcement member 23 is thus formed in an L-shape (or U-shape) in side view. The door D equipped with such reinforcement member 23 increases the rigidity of the lower part of the door.

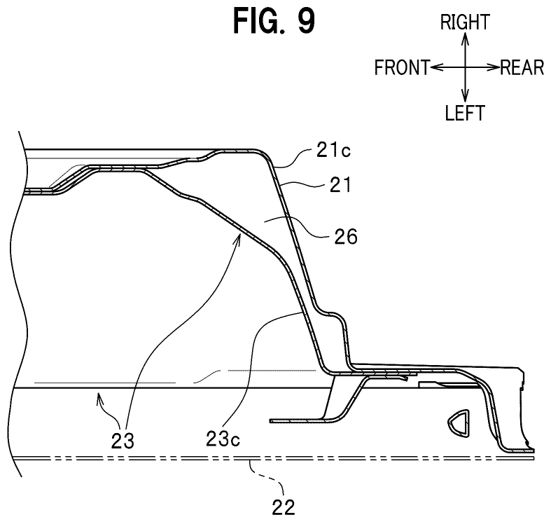

The reinforcement member 23 and inner panel 21 together form a front closed cross-sectional portion 24 (see FIG. 7), a lower closed cross-sectional portion 25 (see FIG. 8), and a rear closed cross-sectional portion 26 (see FIG. 9). Due to this, the reinforcement member 23, which has an L-shape (or U-shape) in side view, is reinforced extending from a forward portion 23a to a rearward portion 23c via a lower portion 23b. An upper portion 23d of the reinforcement member 23 extends to a front lower end portion (to at least a portion of the peripheral edge) of the window opening 21e.

As illustrated in FIG. 7, the front closed cross-sectional portion 24 is formed between the hinge stiffener 28 and the forward portion 21a of the inner panel 21. The front closed cross-sectional portion 24 has a closed cross-section extending in the up-down direction and has an approximately triangular shape with a long length in the left-right direction. The front closed cross-sectional portion 24 extends to the vicinity of the front end portion of the sash 21g. Due to this, the rigidity of the forward portion 21a of the inner panel 21 is increased.

As illustrated in FIG. 8, the lower closed cross-sectional portion 25 is formed between the reinforcement member 23 and the lower portion 21b of the inner panel 21. The lower closed cross-sectional portion 25 has a closed cross-section extending in the front-rear direction and has an approximately rectangular shape elongated in the left-right direction. Due to this, the rigidity of the lower portion 21b of the inner panel 21 is increased. The lower portion 23b of the reinforcement member 23 and the lower portion 21b of the inner panel 21 are connected by slide clips (not shown).

As illustrated in FIG. 9, the rear closed cross-sectional portion 26 is formed between the reinforcement member 23 and the rearward portion 21c of the inner panel 21. The rear closed cross-sectional portion 26 has a closed cross-section extending in the up-down direction and has an approximately rectangular shape elongated in the left-right direction Due to this, the rigidity of the rearward portion 21c of the inner panel 21 is increased. In the case of the present embodiment, the rear closed cross-sectional portion 26 has a shorter dimension in the up-down direction than the front closed cross-sectional portion 24.

### Door Beam

As illustrated in FIG. 6, the door beam 72 is a door reinforcement member for reinforcing the rear door 2. The door beam 72 is disposed slightly obliquely downward in the front-rear direction with respect to the rear door 2. The door beam 72 having a straight shape and the reinforcement member 23 having an L-shape in side view form a truss structure having a triangular configuration in side view. The front end portion 72a of the door beam 72 is detachably attached via a beam bracket 722 to the reinforcement member 23 provided on the forward portion 21a of the inner panel 21.

The rear end portion 72b of the door beam 72 is detachably attached via a beam bracket 723 to the rearward portion 21c of the inner panel 21 and to the rearward portion 23c of the reinforcement member 23. The door beam 72 is composed of a beam body 721, the front beam bracket 722, and the rear beam bracket 723.

The beam body 721 is formed of a metal pipe, like the beam body 711 of the front door 1 (see FIG. 1).

The front beam bracket 722 is a metal plate bracket for attaching the front end portion 72a of the beam body 721 to the forward portion 23a of the reinforcement member 23. The beam bracket 722 has an engagement groove 722a to which the front end portion 72a of the door beam 72 is joined and bolt installation holes (not shown) into which fasteners 724 that detachably fix the beam bracket 722 to the forward portion 23a of the reinforcement member 23 are installed.

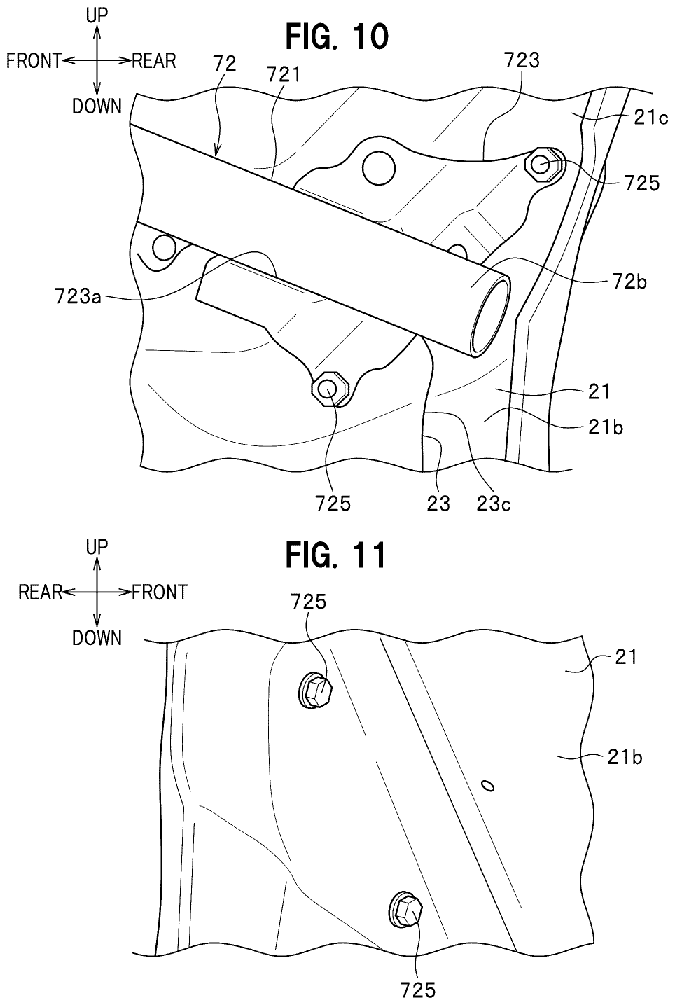

As illustrated in FIG. 10, the rear beam bracket 723 is a metal plate bracket for attaching the rear end portion 72b of the beam body 721 to the rearward portion 21c of the inner panel 21 and to the rearward portion 23c of the reinforcement member 23. The beam bracket 723 has an engagement groove 723a to which the rear end portion 72b of the door beam 72 is engaged and bolt installation holes (not shown) into which fasteners 725 (see FIG. 11) that fix the beam bracket 723 to the rearward portion 21c of the inner panel 21 and to the rearward portion 23c of the reinforcement member 23 are installed.

### Skin Stiffener

As illustrated in FIG. 6, like the skin stiffener 81 of the front door 1, the skin stiffener 82 is a door reinforcement member for reinforcing the rear door 2. The skin stiffener 82 is, for example, formed of a metal sheet member extending in the front-rear direction. The skin stiffener 82 includes a front end portion 82a fixed to the forward portion 23a of the reinforcement member 23 and a rear end portion 82b fixed to the rearward portion 21c of the inner panel 21.

### Skin Upper Stiffener

The skin upper stiffener 92 is a metal reinforcement sheet member disposed on a vehicle outer side lower portion of the window opening 21e of inner panel 21. The skin upper stiffener 92 is fixed extending from the forward portion 23a of the reinforcement member 23 to the rearward portion 21c of the inner panel 21. The skin upper stiffener 92 is located between the inner panel 21 and the outer panel 22.

### Skin Sash Stiffener

The skin sash stiffener 94 is a metal reinforcement sheet member that is placed over the entirety of a forward portion of the sash 21g of the inner panel 21. The skin sash stiffener 94 is installed extending from the front upper end to the front lower end of the sash 21g.

### Door Hinge

As illustrated in FIG. 6, the door hinges 32, 32 are hinge members for mounting the rear door 2 to the front pillar (not shown) to be rotatable with respect to the front pillar. The door hinges 32, 32 are attached to upper and lower portions of the front end portion of the rear door 2, respectively.

### Outer Panel

The outer panel 22 is composed of a thin sheet-like resin member, which is disposed on the vehicle outer side of the inner panel 21. The outer panel 22 is detachably attached to the inner panel 21.

### Working Effects

The vehicle door structure 100 according to the present embodiment is basically configured as described above. Hereinbelow, a description will be given of working effects of the vehicle door structure 100.

As understood from the above description, the doors D shown in FIGS. 1 and 6 are designed to be easily recyclable and lightweight by attachably and detachably mounting the resin outer panels 12, 22 to the inner panels 11, 21, and are designed to increase the rigidity by the reinforcement members 13, 23. As a result, the vehicle door structure 100 according to the embodiment of the present invention can contribute to solving environmental problems that have become a global issue, and can greatly contribute to achieving the Sustainable Development Goals (SDGs).

As illustrated in FIG. 1 or FIG. 6, a vehicle door structure 100 includes: an inner panel 11, 21; an outer panel 12, 22 disposed on the vehicle outer side of the inner panel 11, 21; and a reinforcement member 13, 23 installed between the inner panel 11, 21 and the outer panel 12, 22. The reinforcement member 13, 23 is disposed extending continuously over a forward portion 11a, 21a, a lower portion 11b, 21b and rearward portion 11c, 21c of the inner panels 11, 21.

According to such configuration, the reinforcement member 13, 23 extends continuously over the inner panel 11, 21, from the forward portion 11a, 21a, via the lower portion 11b, 21b, to the rearward portion 11c, 21c. Therefore, as the inner panel 11, 21 is reinforced in the lower portion thereof from the forward portion 11a, 21a to the rearward portion 11c, 21c, the entirety of the lower part of the door D is reinforced.

As illustrated in FIG. 1 or FIG. 6, the reinforcement member 13, 23 forms: a front closed cross-sectional portion 14, 24 (see FIGS. 3 and 7) between the reinforcement member 13, 23 and the forward portion 11a, 21a of the inner panel 11, 21; a lower closed cross-sectional portion 15, 25 (see FIGS. 4 and 8) between the reinforcement member 13, 23 and the lower portion 11b, 21b of the inner panel 11, 21; and a rear closed cross-sectional portion 16, 26 (see FIGS. 5 and 9) between the reinforcement member 13, 23 and the rearward portion 11c, 21c of the inner panel 11, 21.

According to this configuration, the reinforcement member 13, 23, together with the inner panel 11, 21, forms the front closed cross-sectional portion 14, 24 (see FIGS. 3 and 7), the lower closed cross-sectional portion 15, 25 (see FIGS. 4 and 8), and the rear closed cross-sectional portion 16, 26 (see FIGS. 5 and 9). With this, in the front door 1 and rear door 2, the rigidity of the lower part of the door D is effectively increased by forming a continuous closed cross-section formed between the reinforcement member 13, 23 and the inner panel 11, 21 and extending from the forward portion 11a, 21a to the rearward portion 11c, 21c via the lower portion 11b, 21b.

As illustrated in FIG. 1, the inner panel 11 includes an upper portion 11d in which a window opening 11e is formed, and the reinforcement member 13 extends to at least a portion of a peripheral edge of the window opening 11e.

According to this configuration, as the reinforcement member 13 extends to at least a portion of the peripheral edge of the window opening 11e, a sash 11g of the window opening 11e is also reinforced. As a result, as the reinforcement member 13 also functions as a sash reinforcement member for reinforcing the sash 11g, a dedicated sash reinforcement member is not needed and thus the number and weight of the parts are reduced.

As illustrated in FIGS. 1 and 6, the vehicle door structure 100 includes a door beam 71, 72 including a front end portion 71a, 72a and a rear end portion 71b, 72b respectively fixed to the forward portion 11a, 21a and rearward portion 11c, 21c of the inner panel 11, 21 either directly or via the reinforcement member 13, 23, wherein the front end portion 71a, 72a and the rear end portion 71b, 72b of the door beam 71, 72 is fixed to or disposed adjacent to the reinforcement member 13, 23.

According to such configuration, the reinforcement member 13, 23 is disposed extending from the forward portion 11a, 21a to the rearward portion 11c, 21c, and the door beam 71, 72 is connected to the forward portion 11a, 21a and rearward portion 11c, 21c. Due to this, the reinforcement member 13, 23 and the door beam 71, 72 form a truss structure having a triangular shape in side view, which further increases the rigidity of the lower part of the door.

As illustrated in FIGS. 6 and 10, both the front end portion 72a and the rear end portion 72b of the door beam 72 are fixed to the reinforcement member 23.

According to this configuration, the front end portion 72a and the rear end portion 72b of the door beam 72 are fixed to the reinforcement member 23, forming a truss structure with the reinforcement member 23 and the door beam 72. Due to this, the rigidity of the lower part of the door is further enhanced.

As illustrated in FIGS. 1, 2, and 6, the outer panel 12, 22 and the door beam 71, 72 are detachably attached to the inner panel 11, 21.

According to such configuration, the outer panel 12, 22 and door beam 71, 72 can be detached from the inner panel 11, 21 by making them detachable from the inner panel 11, 21. As this makes it possible to attach outfitting items, such as a window regulator 41, to the door D from outside the vehicle, the operability of attaching the outfitting items to the door D is improved. It is possible to increase the rigidity of the inner panel 11, 21 because the outfitting items can be mounted to the door D from outside the vehicle, eliminating the need of forming work holes in the inner panel 11, 21 for mounting the outfitting items.

### Modifications

The invention is not limited to the above embodiments, and various modifications and alterations are possible within the scope of the technical concept, and of course the invention extends to these modifications and alterations.

Regarding the above-described embodiments, as illustrated in FIGS. 1 and 6, description has been given taking a hinged door with the door hinges 31, 32 as an example of the door D. However, the invention is applicable to any open/close body in which an inner panel 11, 21 and/or an outer panel 12, 22 is installable. The door D may be, for example, a sliding door or a gull wing door.

Moreover, description has been given taking a case where the outer panel 12, 22 is formed of a resin sheet member. However, the material of the outer panel 12, 22 is not limited and may be a light alloy such as an aluminum alloy or a magnesium alloy.

What is claimed is:

1. A vehicle door structure comprising:
an inner panel including a forward portion, lower portion, and a rearward portion;
an outer panel disposed on a vehicle outer side of the inner panel; and
a reinforcement member installed between the inner panel and the outer panel,
wherein the reinforcement member is disposed extending continuously over the forward portion, the lower portion, and the rearward portion of the inner panel.

2. The vehicle door structure according to claim 1,
wherein the reinforcement member forms:
a front closed cross-sectional portion between the reinforcement member and the forward portion of the inner panel;
a lower closed cross-sectional portion between the reinforcement member and the lower portion of the inner panel; and
a rear closed cross-sectional portion between the reinforcement member and the rearward portion of the inner panel.

3. The vehicle door structure according to claim 1,
wherein the inner panel further includes an upper portion in which a window opening is formed, and
wherein the reinforcement member extends to at least a portion of a peripheral edge of the window opening.

4. The vehicle door structure according to claim 1, further comprising:
a door beam including a front end portion and a rear end portion respectively fixed to the forward portion and the rearward portion of the inner panel either directly or via the reinforcement member,
wherein the front end portion and the rear end portion of the door beam are fixed to or disposed adjacent to the reinforcement member.

5. The vehicle door structure according to claim 4,
wherein both the front end portion and the rear end portion of the door beam are fixed to the reinforcement member.

6. The vehicle door structure according to claim 4,
wherein the outer panel and the door beam are detachably attached to the inner panel.

7. The vehicle door structure according to claim 5,
wherein the outer panel and the door beam are detachably attached to the inner panel.
